(19) United States
(12) Patent Application Publication
(10) Pub. No.: US 2026/0277574 A1
(43) Pub. Date: Sep. 17, 2026

(54) Graph-Powered Compilable Code Extraction for Migration Workloads

(71) Applicant: Dell Products L.P., Round Rock, TX (US)

(72) Inventors: Andrea Roggerone, Dublin (IE); Brian Rochford, Ovens (IE); Steven Soumpholphakdy, Austin, TX (US); Mauro Silva, Passage West, Cork (IE)

(21) Appl. No.: 19/080,312

(22) Filed: Mar. 14, 2025

(51) Int. Cl. G06F 8/41

(52) U.S. Cl. CPC G06F 8/433; G06F 8/427

(57) ABSTRACT

A system can create a dependency map for computer code, wherein respective nodes of the dependency map comprise respective files of the computer code, wherein respective edges of the dependency map comprise respective dependencies between the respective files, and wherein respective properties of the respective nodes comprise respective computer code callable code construct signatures stored in the respective files. The system can perform a k-hop analysis of the dependency map, wherein a first input parameter to the k-hop analysis comprises a location in the computer code from which to begin the k-hop analysis, and wherein a second input parameter to the k-hop analysis comprises a depth value. The system can determine a first subgroup of the files to extract that corresponds an output of the performing of the k-hop analysis, and a second subgroup of the files for which to create stub files that corresponds to the output.

### BACKGROUND

Software code can be migrated from one computer system to another computer system.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can create a dependency map for computer code, wherein respective nodes of the dependency map comprise respective files of the computer code, wherein respective edges of the dependency map comprise respective dependencies between the respective files, and wherein respective properties of the respective nodes comprise respective computer code callable code construct signatures stored in the respective files. The system can perform a k-hop analysis of the dependency map, wherein a first input parameter to the k-hop analysis comprises a location in the computer code from which to begin the k-hop analysis, wherein a second input parameter to the k-hop analysis comprises a depth value, wherein the performing of the k-hop analysis starts from the location in the computer code and extends through the computer code according to the depth value. The system can determine a first subgroup of the files to extract that corresponds an output of the performing of the k-hop analysis, and a second subgroup of the files for which to create stub files that corresponds to the output. The system can store a first indication of the first subgroup of the files and a second indication of the second subgroup of the files.

An example method can comprise creating, by a system comprising at least one processor, a dependency map for computer code, wherein respective nodes of the dependency map comprise respective files of the computer code, wherein respective edges of the dependency map comprise respective dependencies between the respective files, and wherein respective properties of the respective nodes comprise respective computer code callable code construct signatures stored in the respective files. The method can further comprise performing, by the system, a nearest-neighbors analysis of the dependency map, wherein a first input parameter to the nearest-neighbors analysis comprises a location in the computer code, wherein a second input parameter to the nearest-neighbors analysis comprises a depth value, wherein the performing of the nearest-neighbors analysis starts from the location in the computer code and extends through the computer code according to the depth value. The method can further comprise determining, by the system, a first subgroup of the files to extract that corresponds an output of the performing of the nearest neighbors analysis, and a second subgroup of the files for which to create stub files that corresponds to the output.

An example non-transitory computer-readable medium can comprise instructions that, in response to execution, cause a system comprising a processor to perform operations. These operations can comprise creating a dependency map for computer code, wherein respective nodes of the dependency map comprise respective files of the computer code, and wherein respective edges of the dependency map comprise respective dependencies between the respective files. These operations can further comprise performing a nearest-neighbors analysis of the dependency map, wherein a first input parameter to the nearest-neighbors analysis comprises a location in the computer code, and wherein a second input parameter to the nearest-neighbors analysis comprises a depth value. These operations can further comprise determining a first subgroup of the files to extract that corresponds an output of the performing of the nearest-neighbors analysis, and a second subgroup of the files for which to create stub files that corresponds to the output.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate graph-powered compilable code extraction for migration workloads, in accordance with an embodiment of this disclosure;

FIG. 2 illustrates another example system architecture that can facilitate graph-powered compilable code extraction for migration workloads, in accordance with an embodiment of this disclosure;

FIG. 3 illustrates an example of a k-hop process, and that can facilitate graph-powered compilable code extraction for migration workloads, in accordance with an embodiment of this disclosure;

FIG. 4 illustrates another example of a k-hop process, and that can facilitate graph-powered compilable code extraction for migration workloads, in accordance with an embodiment of this disclosure;

FIG. 5 illustrates an example system architecture for dependency map generation, and that can facilitate graph-powered compilable code extraction for migration workloads, in accordance with an embodiment of this disclosure;

FIG. 6 illustrates an example system architecture for recommendation/code extraction, and that can facilitate graph-powered compilable code extraction for migration workloads, in accordance with an embodiment of this disclosure;

FIG. 7 illustrates another example system architecture for dependency map generation, and that can facilitate graph-powered compilable code extraction for migration workloads, in accordance with an embodiment of this disclosure;

FIG. 8 illustrates another example system architecture for recommendation/code extraction, and that can facilitate graph-powered compilable code extraction for migration workloads, in accordance with an embodiment of this disclosure;

FIG. 9 illustrates another example process flow that can facilitate graph-powered compilable code extraction for migration workloads, in accordance with an embodiment of this disclosure;

FIG. 10 illustrates another example process flow that can facilitate graph-powered compilable code extraction for migration workloads, in accordance with an embodiment of this disclosure;

FIG. 11 illustrates another example process flow that can facilitate graph-powered compilable code extraction for migration workloads, in accordance with an embodiment of this disclosure; and

FIG. 12 illustrates an example block diagram of a computer operable to execute an embodiment of this disclosure.

### DETAILED DESCRIPTION

### Overview

The present techniques can generally relate to software engineering and data management.

Large code migrations can present challenges in terms of:
Dependency management: making sure that all the dependencies are imported, satisfied and compatible with the new code and platform.
Scale and complexity: large codebases can contain so much code that even only identifying a small piece of code to be ported can be daunting.
Test and validation: Getting the code to compile and testing it when porting legacy code, and it can be that there are no tests to help.
Etc.

Ultimately, taking a piece of code and all its dependencies, and getting it to compile, can be challenging, particularly if the code is polyglot and contains many nested dependencies, and potentially no tests or documentation.

Prior approaches to tackle these challenges can rely on labor-intensive discovery work, followed by manual work to make it compile and to write the tests for the test framework of choice. These prior approaches can have problems relating to being time consuming, and relying heavily on developer expertise.

In contrast, the present techniques can be implemented to extract the code that needs to be ported (based on some provided criteria) from a codebase, and to provide a clear indication of the code to port and the stubs needed for its dependencies.

In an example, the problems with the prior approaches can arise in the context of a migration of code from one operating system to another operating system. In particular, problems can relate to:
The sheer amount of code (as well as it being polyglot).
Its complexity and many nested dependencies.
The challenges to test it.
The respective idiosyncrasies of the two operating systems.

The above can make taking a piece of code, identifying all its dependencies, and getting it to build/compile on the two respective operating systems a challenge. Prior approaches can be iterative and can involve:
1. Creating CMake files to match Berkeley Software Distribution (BSD) makefiles to start compilation.
2. Compiling, observing errors, fixing the errors, and re-compiling.
3. Repeating step (2) until success.

The present techniques can be implemented to increase developer productivity by automating the extraction of the code that needs to be ported (based on some provided criteria) from a codebase, and providing clear indication of headers, prototypes, and stubs that are needed to reconcile dependencies needed for successful compilation.

In some examples, the present techniques can provide what is needed to compile locally within the target directory, rather than within the larger build ecosystem. The present techniques can address problems with prior approaches by:
Creating a dependency graph of the codebase where files are nodes and relationships are dependencies.
Augmenting the file node properties with the automatically extracted method/class/function signature.
Leveraging user-provided parameters along with an H-hop neighborhood algorithm (described further below) to identify the code to port and its dependencies-both real and/or stubbed-depending on the user query.

A result of implementing the present techniques can be a recommendation, comprising:
The files to extract (along their location in the repository, or repo).
Dependencies.
Stubbed code for dependencies according to user query filters.

This can increase efficiency and speed by eliminating the need for manual discovery. It can also abstract this process from the developer experience.

Prior approaches can omit an ability to extract code and only the necessary dependencies from a codebase, while autogenerating stubs, so that the extracted code is left in a compile-able state.

In some examples, the present techniques can be implemented via the following:

Dependency map generation: a scanning tool can be used to scan the code from a given repository, build a dependency map where files are nodes and relationships are dependencies, and store it in a graph database. The class/methods/functions signatures can be included as properties so that stubs can be created in the recommendation/code extraction flow.

Recommendation/code extraction: given a query provided by the user in the form of [file/directory location, relationships degree to include (e.g., 2)], the recommender can leverage a K-hop neighborhood algorithm to identify code to extract and stubs to generate. The recommendation can then be used directly for visualization, and/or can be fed to a build pipeline (sometimes referred to as a devops pipeline) to write in a repository, compile, etc.

The present techniques can, given a file or folder to migrate, leverage a K-hop neighborhood algorithm, and in-graph language-specific function/class signatures, to identify dependencies and stubs to be used for the code to be migrated in a compilable state.

The present techniques can be implemented to use code-agnostic dependency graphs to fuel migration recommendations for a large codebase, and facilitate a compilable code extraction process for large migration workloads.

The present techniques can be language agnostic, can increase efficiency and speed for migrations of large codebases by eliminating the need for manual discovery, and can fuel code extraction automation.

### Example Architectures, Etc.

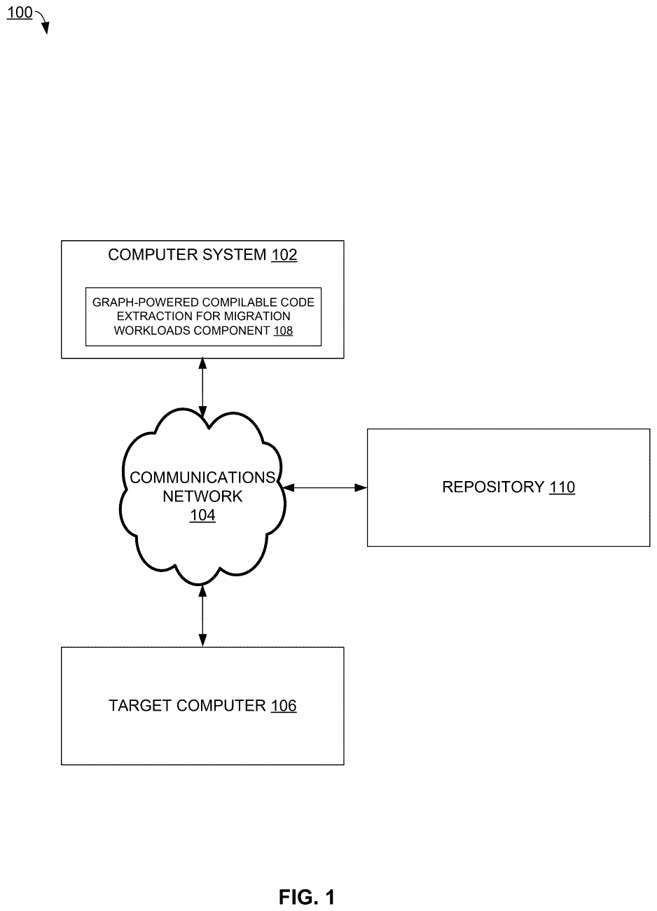

FIG. 1 illustrates an example system architecture 100 that can facilitate graph-powered compilable code extraction for migration workloads, in accordance with an embodiment of this disclosure.

System architecture 100 comprises computer system 102, communications network 104, target computer 106, and repository 110. In turn, computer system 102 comprises graph-powered compilable code extraction for migration workloads component 108.

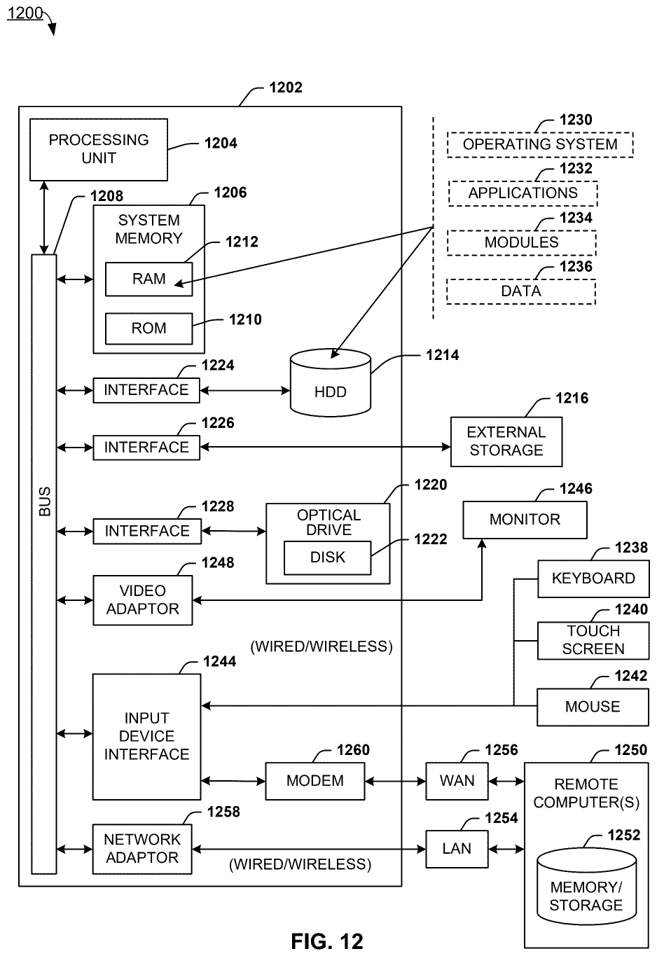

Each of computer system 102, target computer 106, and/or repository 110 can be implemented with part(s) of computing environment 1200 of FIG. 12. Communications network 104 can comprise a computer communications network, such as the Internet.

There can be a desire to compile a sub-portion of a codebase stored in repository 110 on target computer 106. It can be a sub-portion, e.g., for testing purposes, where migrating and compiling the entire codebase can unnecessarily consume computing resources. Graph-powered compilable code extraction for migration workloads component 108 can receive as input a starting file within the codebase, and a degree of depth to migrate (e.g., a number of dependencies across files), and determine a sub-portion of that codebase for this migration to target computer 106.

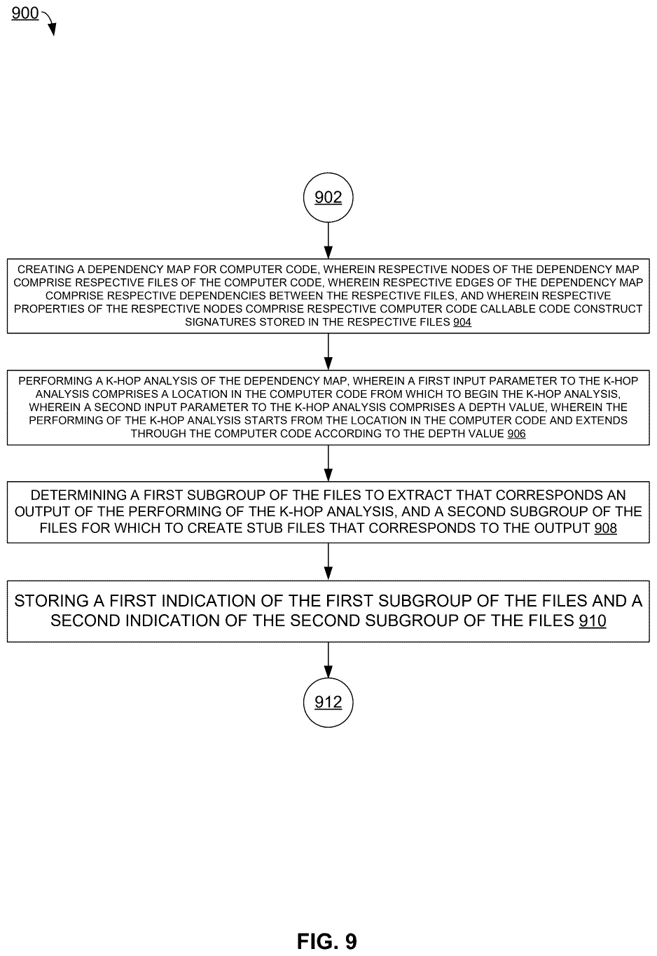

In some examples, graph-powered compilable code extraction for migration workloads component 108 can implement part(s) of the process flows of FIGS. 9-11 to implement graph-powered compilable code extraction for migration workloads.

It can be appreciated that system architecture 100 is one example system architecture for graph-powered compilable code extraction for migration workloads, and that there can be other system architectures that facilitate graph-powered compilable code extraction for migration workloads.

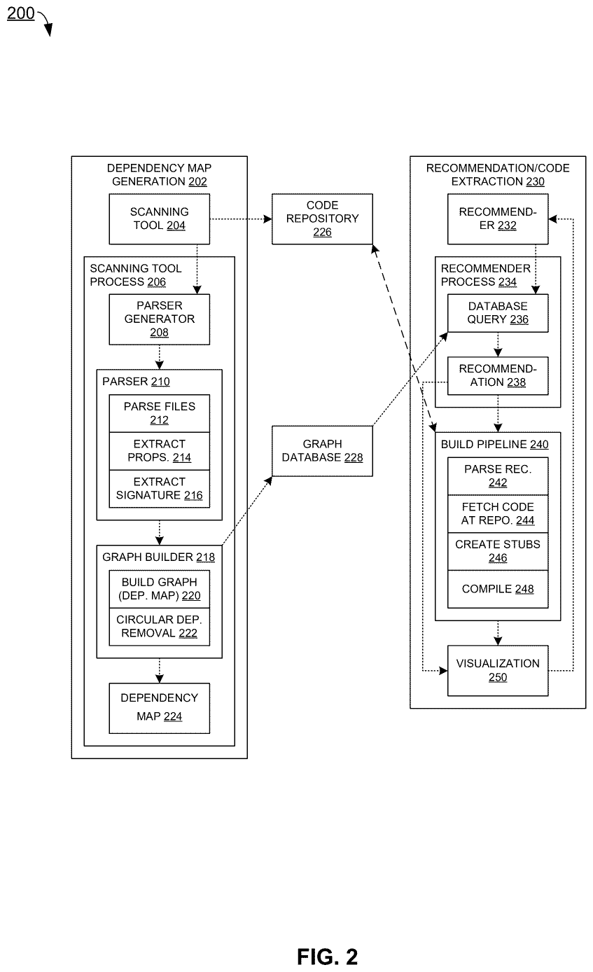

FIG. 2 illustrates another example system architecture 200 that can facilitate graph-powered compilable code extraction for migration workloads, in accordance with an embodiment of this disclosure. In some examples, part(s) of system architecture 200 can be used by part(s) of system architecture 100 of FIG. 1 to facilitate graph-powered compilable code extraction for migration workloads.

System architecture 200 comprises dependency map generation 202, scanning tool 204, scanning tool process 206, parser generator 208, parser 210, parse files 212, extract properties 214, extract signature 216, graph builder 218, build graph (dependency map) 220, circular dependencies removal 222, dependency map 224, code repository 226, graph database 228, recommendation/code extraction 230, recommender 232, recommender process 234, database query 236, recommendation 238, build pipeline 240, parse recommendation 242, fetch code from repository 244, create stubs 246, compile 248, and visualization 250.

In some examples, the present techniques can be implemented via the following:
Dependency map generation 202: a scanning tool can be used to scan the code from a given repository, build a dependency map where files are nodes and relationships are dependencies, and store it in a graph database. The class/methods/functions signatures can be included as properties so that stubs can be created in the recommendation/code extraction flow.
Recommendation/code extraction 230: given a query provided by the user in the form of [file/directory location, relationships degree to include (e.g., 2)], the recommender can leverage a K-hop neighborhood algorithm to identify code to extract and stubs to generate. The recommendation can then be used directly for visualization, and/or can be fed to a build pipeline to write in a repo, compile, etc.

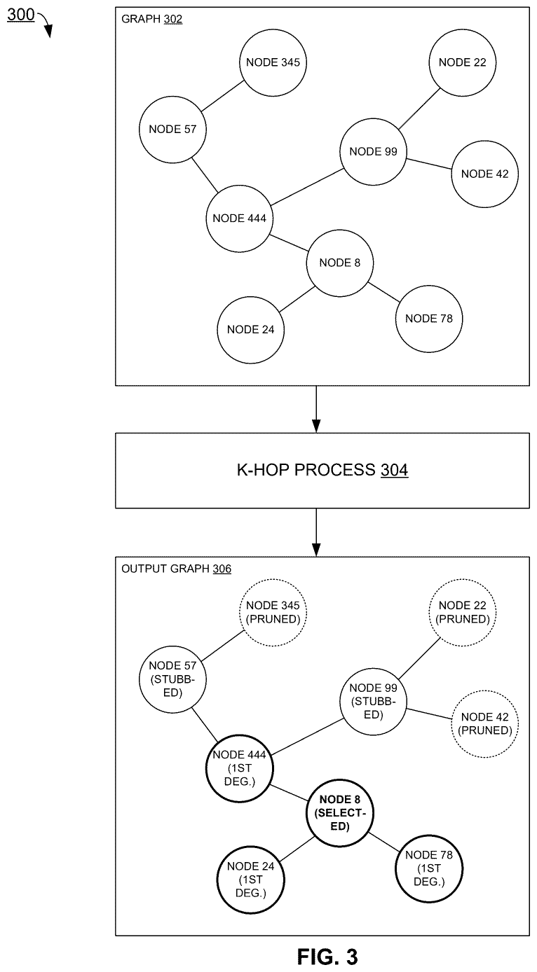

FIG. 3 illustrates an example 300 of a k-hop process, and that can facilitate graph-powered compilable code extraction for migration workloads, in accordance with an embodiment of this disclosure. In some examples, part(s) of example 300 can be used by part(s) of system architecture 100 of FIG. 1 to facilitate graph-powered compilable code extraction for migration workloads.

Example 300 comprises graph 302, k-hop process 304, and output graph 306.

Example 300 illustrates a scenario where there a dependency graph such as graph 302, where nodes are files and edges are the files' dependencies, a user account wants to create compilable code to migrate node 8 (e.g., file8 with location “ . . . / . . . file8”), and the user account specifies that only first degree dependencies are to be ported.

In this scenario, k-hop process 304 is used to return the list of relevant neighbors and the recommendation, e.g., for each node, an identifier of the node, a degree of distance from the root node (here, node 8), a location of the node, an indication of whether the node's file is to be stubbed, and a code signature of the node.

An output of k-hop process 304 is output graph 306, where a visual representation of the result indicates the selected node, nodes that are in the selected range (here, a 1^{st} degree relationship) and will be migrated as they are, nodes that will be stubbed (where indications for the stub can be provided in a query result), and node that will be pruned as part of migrating.

In graph 302, the nodes have among their properties a file location (e.g., “ . . . / . . . file8”) and a code signature, e.g.:
Function: def k-hop_neighborhood (graph, start_node, k)
Parameters: graph (dict), start node (int)
Returns: set

K-hop process 304 can determine nodes of graph 302 that are at most (k) hops away from the starting node (v):

Nₖ(v) = {u ∈ V | distance(v, u) ≤ k}
(G=(V,E): graph with (V) nodes and (E) edges
(v): node in V
(k): integer
Nₖ(v) = k-hop neighborhood of (v)
{distance(v, u): Represents the shortest path between nodes (v) and (u)

Where a folder is considered instead of a file, the list of files within a given folder can be considered a subgraph of the dependency graph. The K-hop neighborhood process can identify nodes within a specified number of hops from any node within the subgraph.

It can be that a K-hop process is used because, in some examples, it can have localized search, flexibility and performance advantages relative to other approaches, which can make it more effective for large graphs compared to those approaches.

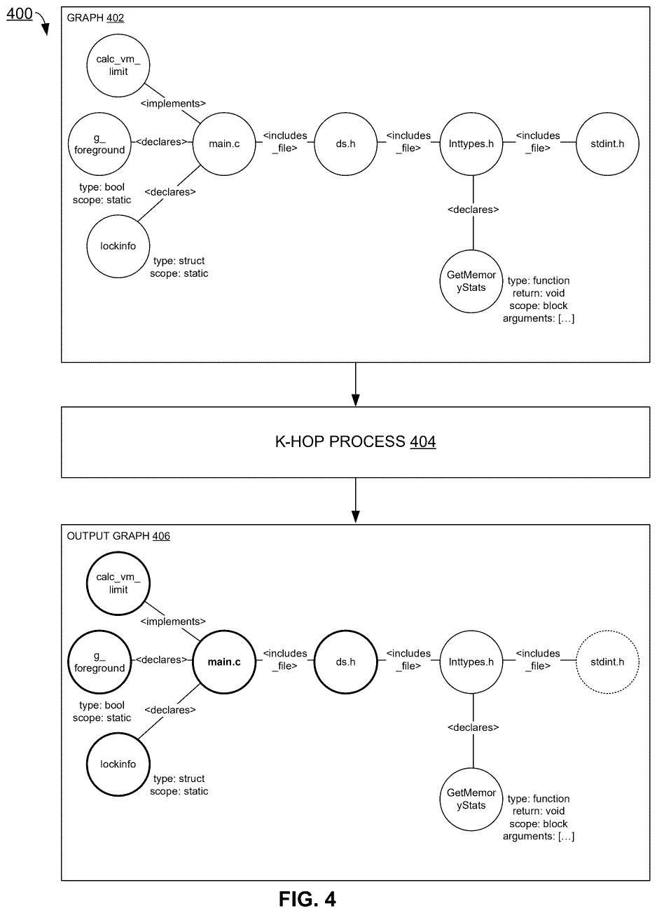

FIG. 4 illustrates another example 400 of a k-hop process, and that can facilitate graph-powered compilable code extraction for migration workloads, in accordance with an embodiment of this disclosure. In some examples, part(s) of example 400 can be used by part(s) of system architecture 100 of FIG. 1 to facilitate graph-powered compilable code extraction for migration workloads.

Example 400 comprises graph 402, k-hop process 404, and output graph 406.

Relative to the more general example 300 of FIG. 3, example 400 illustrates a k-hop process as applied to an example codebase that is represented by graph 402.

In output graph 406, a visual representation indicates which nodes are migrated as they are, stubbed, and pruned. The nodes that are bolded indicate nodes/files that will be migrated as they are. The nodes/files that have a normal weight line will be stubbed and those stubs migrated. The nodes/files with a dashed line will be pruned (and not migrated).

Consider this example, where a dependency graph represents code and its relationships. A user wants to create compilable code to migrate main.c, under a particular library. In this example, the user specifies that only first degree dependencies should be ported.

Output graph 406 can comprise a visual representation of the result where there is a selected node; there are nodes that are in the range selected by the user (1st degree relationship) and will be migrated as they are; there are nodes that will be stubbed (and indications for the stub are provided in the query result); and there are nodes that will be pruned.

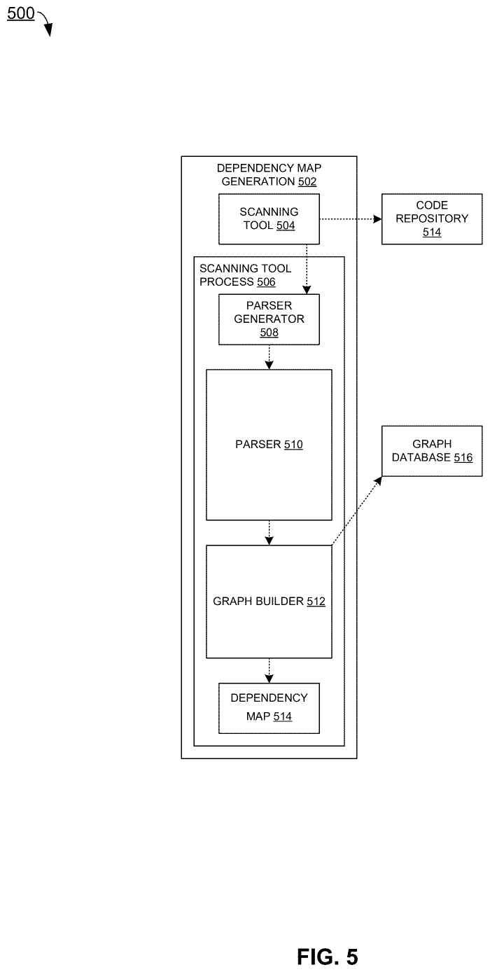

FIG. 5 illustrates an example system architecture 500 for dependency map generation, and that can facilitate graph-powered compilable code extraction for migration workloads, in accordance with an embodiment of this disclosure. In some examples, part(s) of system architecture 500 can be used by part(s) of system architecture 100 of FIG. 1 to facilitate graph-powered compilable code extraction for migration workloads.

System architecture 500 comprises dependency map generation 502, scanning tool 504, scanning tool process 506, parser generator 508, parser 510, graph builder 512, dependency map 514, code repository 516, and graph database 518.

Dependency map generation components can be as follows:
Scanning tool 504: An application/service that scans a code repository upon request from the user and generates a dependency graph.
Code repository 516: a storage location where software code is kept, managed, and tracked.
Scanning tool process 506:
   Parser generator 508: A tool to generate and run parsers according to the required programming language.
   Parser 510: This builds a concrete syntax tree for a source file and efficiently updates the syntax tree as the source file is edited. It can be leveraged to create attribute dependency graphs, control flow graphs (CFGs), etc. The parser can take care of extracting file signatures, and what is used to create node properties.
   Graph builder 512: This creates and stores a dependency graph in the graph database.
   Dependency map 514: A graph of service dependencies.
Graph database 518: A type of NoSQL database designed to represent and store data in a graph structure.

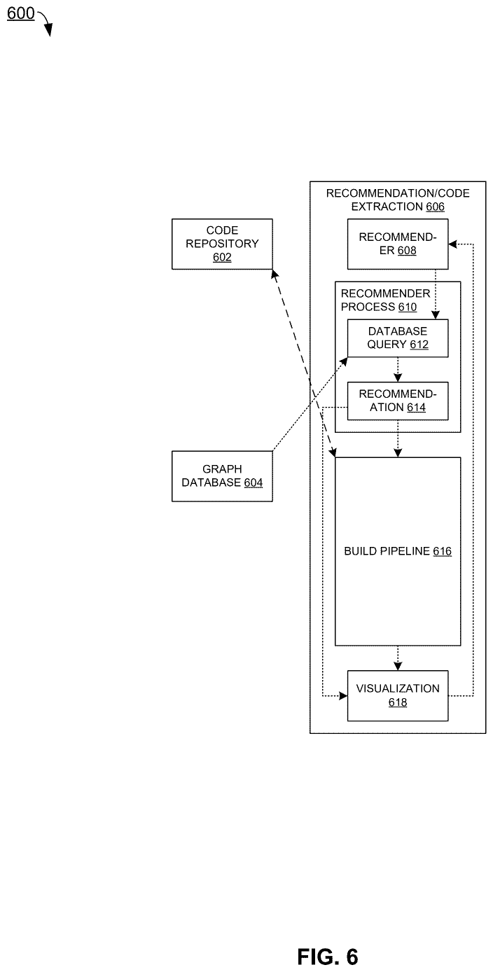

FIG. 6 illustrates an example system architecture 600 for recommendation/code extraction, and that can facilitate graph-powered compilable code extraction for migration workloads, in accordance with an embodiment of this disclosure. In some examples, part(s) of system architecture 600 can be used by part(s) of system architecture 100 of FIG. 1 to facilitate graph-powered compilable code extraction for migration workloads.

System architecture 600 comprises code repository 602, graph database 604, recommendation/code extraction 606, recommender 608, recommender process 610, database query 612, recommendation 614, build pipeline 616, and visualization 618.

Recommendation/code extraction components can be as follows:
Code repository 602: A storage location where software code is kept, managed, and tracked.
Graph database 604: A type of NoSQL database designed to represent and store data in a graph structure.
Recommender 608: Triggered by the user, the recommender can take in input of the user query in terms of file/folder to port, repository, degree of relationships to consider, and output a recommendation.
Recommender process 610:
   Database query 612: run a query against the graph database, leveraging a K-hop neighborhood technique and the parameters provided by the user.
   Recommendation 614: A recommendation of code to extract and stubs needed e.g.,

| Node | Degree | File Location | isStub | Signature |
|---|---|---|---|---|
| Node(24) | 1^{st} | /.../file24 | No | [...code...] |
| Node(57) | 2^{nd} | /.../file57 | Yes | [...code...] |

Build pipeline 616: This takes in input the recommendation and fetches code from original repo, adds stubs where needed, and compiles the code (and/or builds it), etc.
Visualization 618: A component to visualize the raw recommendation or the result of the pipeline in a meaningful way (e.g., via a dashboard).

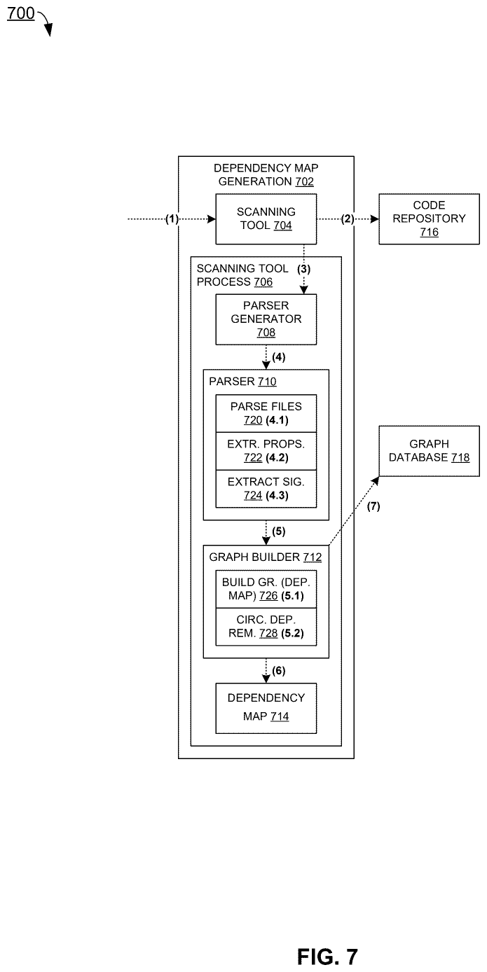

FIG. 7 illustrates another example system architecture 700 for dependency map generation, and that can facilitate graph-powered compilable code extraction for migration workloads, in accordance with an embodiment of this disclosure. In some examples, part(s) of system architecture 700 can be used by part(s) of system architecture 100 of FIG. 1 to facilitate graph-powered compilable code extraction for migration workloads.

System architecture 700 comprises dependency map generation 702, scanning tool 704, tool process 706, parser generator 708, parser 710, graph builder 712, dependency map 714, code repository 716, graph database 718, parse files 720, extract properties 722, extract signature 724, build graph (dependency map) 726, and circular dependencies removal 728.

A dependency map generation flow can be as follows:
1. The user initializes the scanning tool.
2. The scanning tool fetches the relevant repository and starts scanning it.
3. The parser generator creates a parser for the language to scan, unless one was previously created.
4. The parser is generated, and:
   4.1. Files from the repo are parsed.
   4.2. Properties like file name, location, etc., are extracted from the file.
   4.3. By leveraging libraries, the signatures of the methods/functions/classes can be extracted.
5. Extracted properties and signatures can then be passed to the graph builder, which can:
   5.1. Build a graph using files as nodes and dependencies as edges. Nodes properties can be based on properties extracted in step 4.2, in addition to the files signatures extracted in step 4.3.
   5.2. Remove circular dependencies.
6. Output the dependency map
7. Store the dependency map in the graph database.

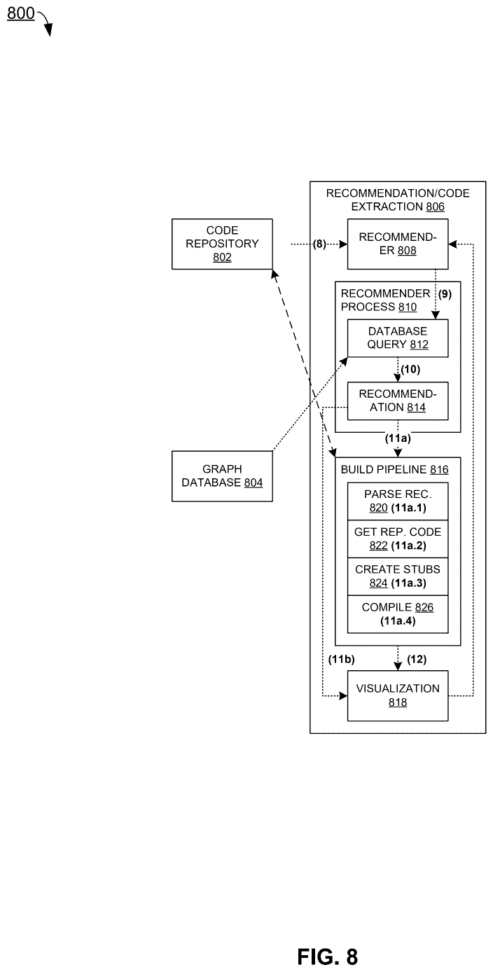

FIG. 8 illustrates another example system architecture 800 for recommendation/code extraction, and that can facilitate graph-powered compilable code extraction for migration workloads, in accordance with an embodiment of this disclosure. In some examples, part(s) of system architecture 800 can be used by part(s) of system architecture 100 of FIG. 1 to facilitate graph-powered compilable code extraction for migration workloads.

System architecture 800 comprises code repository 802, graph database 804, recommendation/code extraction 806, recommender 808, recommender process 810, database query 812, recommendation 814, build pipeline 816, visualization 818, parse recommendation 820, fetch code from repository 822, create stubs 824, and compile 826.

A recommendation/code extraction flow can be as follows (with numbering continued from FIG. 7):
8. The recommendation user can select relevant parameters and trigger the recommender.
9. The recommender can execute a query against the graph database. It can leverage a K-hop neighborhood algorithm.
10. The recommendation can be returned in a format like a JavaScript Object Notation (JSON) format.

In some examples, at this point there can be two possible paths:
11a. The recommendation is ingested by a build pipeline that:
   11a.1: Parses the recommendation.
   11a.2: Based on the recommendation, fetches the relevant code to migrate from the code repository.
   11a.3: Uses code in the signature property of the recommendation to create relevant stubs.
   11a.4: The code is compiled. If the compilation:
      Passes: the recommendation applied everything needed to work, and a diff is generated to be code reviewed;
      Fails: The recommendation is summarized, the build failure is output, and a diff of the recommendation is provided.
   11b. The recommendation is displayed through the visualization component
   12. The result from the pipeline is displayed by the visualization component.

### Example Process Flows

FIG. 9 illustrates an example process flow 900 that can facilitate graph-powered compilable code extraction for migration workloads, in accordance with an embodiment of this disclosure. In some examples, one or more embodiments of process flow 900 can be implemented by graph-powered compilable code extraction for migration workloads component 108 of FIG. 1, or computing environment 1200 of FIG. 12.

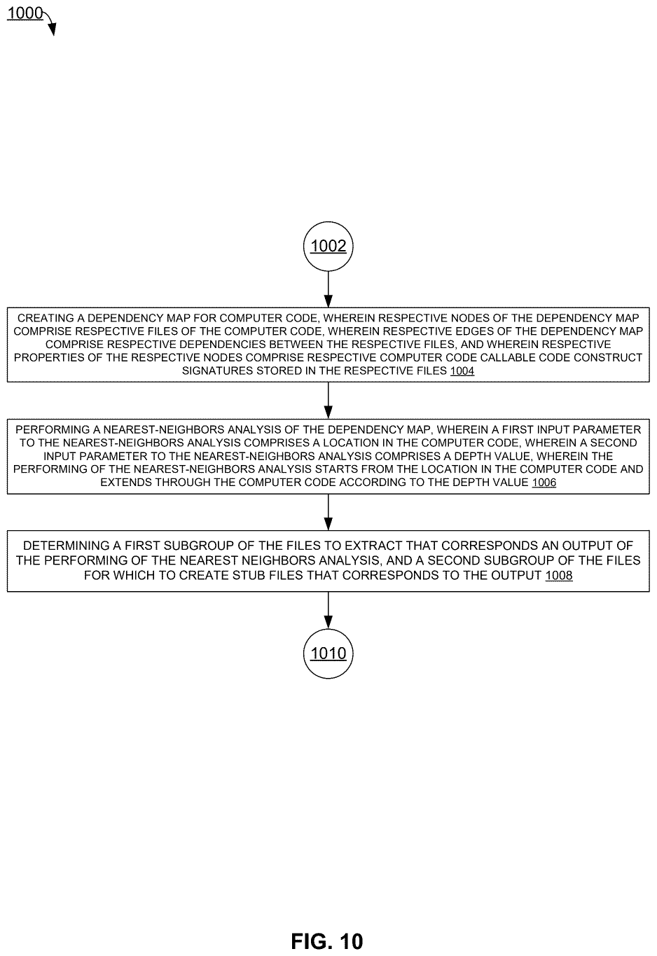

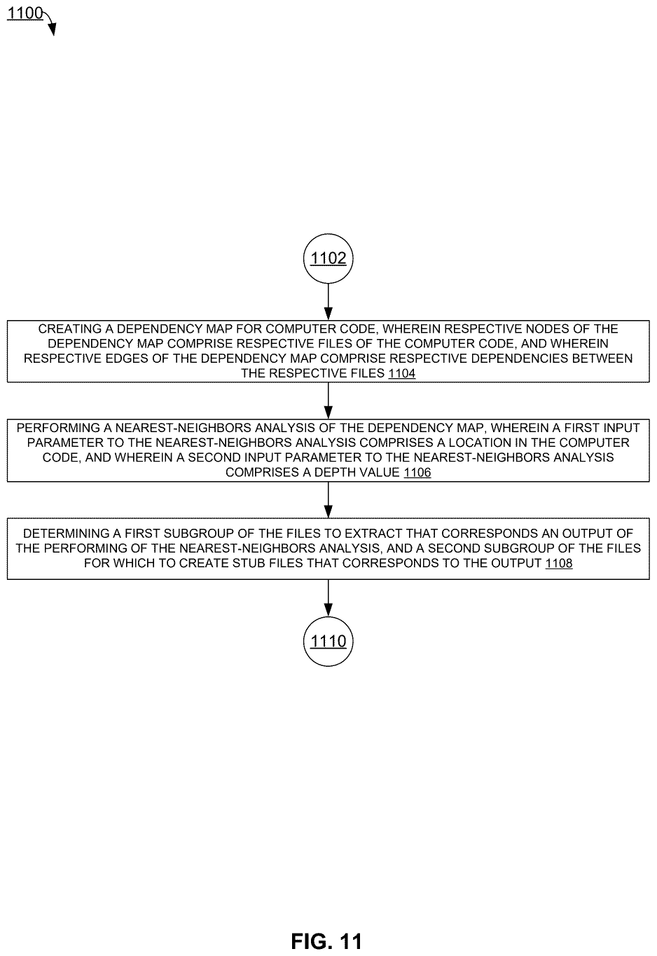

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 1000 of FIG. 10, and/or process flow 1100 of FIG. 11.

Process flow 900 begins with 902, and moves to operation 904.

Operation 904 depicts creating a dependency map for computer code, wherein respective nodes of the dependency map comprise respective files of the computer code, wherein respective edges of the dependency map comprise respective dependencies between the respective files, and wherein respective properties of the respective nodes comprise respective computer code callable code construct signatures stored in the respective files. Using the example of FIG. 2, this can be performed in a similar manner as by dependency map generation 202.

In some examples, the creating of the dependency map for the computer code comprises omitting a circular dependency within the computer code from being represented in the dependency map. That is, circular dependencies can be removed from a dependency map, such as by circular dependencies removal 726 of FIG. 7.

In some examples, the callable code construct signatures comprise at least one method, at least one function, or at least one class. That is, file node properties can be augmented with extracted method/class/function signatures. A callable code construct can generally comprise a programming language segment of code that can be invoked like a function.

After operation 904, process flow 900 moves to operation 906.

Operation 906 depicts performing a k-hop analysis of the dependency map, wherein a first input parameter to the k-hop analysis comprises a location in the computer code from which to begin the k-hop analysis, wherein a second input parameter to the k-hop analysis comprises a depth value, wherein the performing of the k-hop analysis starts from the location in the computer code and extends through the computer code according to the depth value. This can be performed in a similar manner as example 300 of FIG. 3 and/or example 400 of FIG. 4.

In some examples, the first subgroup of the files corresponds to at least one inner level of the output, and wherein the second subgroup of the files corresponds to an outer level of the output. That is, with the result of a k-hop process, the outermost layer of nodes can correspond to files that are stubbed. a stub file can generally comprise a subset of a file of computer code that maintains method signatures of the code without the body of the code, and can be used as a placeholder when linking compiled code. In this way, less than the entire code base can be migrated, and can still be compiled at its destination.

In some examples, at least one file of the files is omitted from the first subgroup and from the second subgroup. That is, at least one file can be pruned, so as not to be migrated. In this way, less than the entire code base can be migrated, and can still be compiled at its destination.

After operation 906, process flow 900 moves to operation 908.

Operation 908 depicts determining a first subgroup of the files to extract that corresponds an output of the performing of the k-hop analysis, and a second subgroup of the files for which to create stub files that corresponds to the output. Using the example of FIG. 2, this can be performed in a similar manner as by recommendation/code extraction 230.

After operation 908, process flow 900 moves to operation 910.

Operation 910 depicts storing a first indication of the first subgroup of the files and a second indication of the second subgroup of the files.

In some examples, operation 910 comprises determining at least one dependency of the first subgroup of the files or the second subgroup of the files, and storing a third indication of the at least one dependency with the first indication of the first subgroup of the files and the second indication of the second subgroup of the files. That is, what can be stored can be a recommendation that comprises files to extract, along with their location in a repository, dependencies, and stubbed code for dependencies according to user query filters.

In some examples, the computer code is stored on a first computing system, and operation 910 comprises copying the first subgroup of the files and the stub files for the second subgroup of the files from the first computing system and to a second computing system. In some examples, this comprises compiling the first subgroup of the files on the second computing system, wherein the compiling is performed based on the stub files and independently of at least one file of the computer code that is outside of the first subgroup of the files. That is, the present techniques can be implemented to determine a part of a code base to port to another computer, and its dependencies-both real and/or stubbed-depending on a user query.

After operation 910, process flow 900 moves to 912, where process flow 900 ends.

FIG. 10 illustrates another example process flow 1000 that can facilitate graph-powered compilable code extraction for migration workloads, in accordance with an embodiment of this disclosure. In some examples, one or more embodiments of process flow 1000 can be implemented by graph-powered compilable code extraction for migration workloads component 108 of FIG. 1, or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 900 of FIG. 9, and/or process flow 1100 of FIG. 11.

Process flow 1000 begins with 1002, and moves to operation 1004.

Operation 1004 depicts creating a dependency map for computer code, wherein respective nodes of the dependency map comprise respective files of the computer code, wherein respective edges of the dependency map comprise respective dependencies between the respective files, and wherein respective properties of the respective nodes comprise respective computer code callable code construct signatures stored in the respective files. In some examples, operation 1004 can be implemented in a similar manner as operation 904 of FIG. 9.

In some examples, operation 1004 comprises creating a concrete syntax tree from the computer code, wherein the creating of the dependency map is based on the concrete syntax tree. This can be implemented such as by parser 510 of FIG. 5, where a concrete syntax tree generally comprises a tree representation of the syntactic structure of a source code file, preserving the original syntax.

After operation 1004, process flow 1000 moves to operation 1006.

Operation 1006 depicts performing a nearest-neighbors analysis of the dependency map, wherein a first input parameter to the nearest-neighbors analysis comprises a location in the computer code, wherein a second input parameter to the nearest-neighbors analysis comprises a depth value, wherein the performing of the nearest-neighbors analysis starts from the location in the computer code and extends through the computer code according to the depth value. In some examples, operation 1006 can be implemented in a similar manner as operation 906 of FIG. 9.

In some examples, the location in the computer code identifies a directory that comprises first files, and the nearest-neighbors analysis is performed relative to each of the first files. That is, where a folder is considered instead of a file, the list of files within a given folder can be considered a subgraph of the dependency graph. The K-hop neighborhood process can identify nodes within a specified number of hops from any node within the subgraph.

After operation 1006, process flow 1000 moves to operation 1008.

Operation 1008 depicts determining a first subgroup of the files to extract that corresponds an output of the performing of the nearest neighbors analysis, and a second subgroup of the files for which to create stub files that corresponds to the output. In some examples, operation 1008 can be implemented in a similar manner as operation 908 of FIG. 9.

In some examples, operation 1008 comprises creating a visualization of the first subgroup of the files and of the second subgroup of the files. In some examples, this comprises providing, to a build pipeline, a first indication of the first subgroup of the files and a second indication of the second subgroup of the files, the build pipeline writing first subgroup of the files and the stub files for the second subgroup of the files to a repository. That is, a visualization of the result can be generated (e.g., as in visualization 818 of FIG. 8), and/or the result can be fed to a build pipeline to write to a repository, compile, etc. (e.g., as in build pipeline 816).

In some examples, operation 1008 comprises identifying a header or a prototype from the computer code, wherein the header or the prototype reconciles a dependency of the first subgroup of the files, and wherein the header or the prototype facilitates compilation of the first subgroup of the files. That is, the present techniques can be implemented to increase developer productivity by automating the extraction of the code that needs to be ported (based on some provided criteria) from a codebase, and providing clear indication of headers, prototypes, and stubs that are needed to reconcile dependencies needed for successful compilation.

After operation 1008, process flow 1000 moves to 1010, where process flow 1000 ends.

FIG. 11 illustrates another example process flow 1100 that can facilitate graph-powered compilable code extraction for migration workloads, in accordance with an embodiment of this disclosure. In some examples, one or more embodiments of process flow 1100 can be implemented by graph-powered compilable code extraction for migration workloads component 108 of FIG. 1, or computing environment 1200 of FIG. 12.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 900 of FIG. 9, and/or process flow 1000 of FIG. 10.

Process flow 1100 begins with 1102, and moves to operation 1104.

Operation 1104 depicts creating a dependency map for computer code, wherein respective nodes of the dependency map comprise respective files of the computer code, and wherein respective edges of the dependency map comprise respective dependencies between the respective files. In some examples, operation 1104 can be implemented in a similar manner as operation 904 of FIG. 9.

In some examples, the respective nodes comprise respective properties, the respective properties further comprise respective file names of the respective files, ad wherein the respective properties further comprise respective file system path storage locations of the respective files. That is, properties like file name, file location, etc., can be extracted from a file.

After operation 1104, process flow 1100 moves to operation 1106.

Operation 1106 depicts performing a nearest-neighbors analysis of the dependency map, wherein a first input parameter to the nearest-neighbors analysis comprises a location in the computer code, and wherein a second input parameter to the nearest-neighbors analysis comprises a depth value. In some examples, operation 1106 can be implemented in a similar manner as operation 906 of FIG. 9.

After operation 1106, process flow 1100 moves to operation 1108.

Operation 1108 depicts determining a first subgroup of the files to extract that corresponds an output of the performing of the nearest-neighbors analysis, and a second subgroup of the files for which to create stub files that corresponds to the output. In some examples, operation 1108 can be implemented in a similar manner as operation 908 of FIG. 9.

In some examples, operation 1108 comprises providing a first indication of the first subgroup of the files and a second indication of the second subgroup of the files to a build pipeline, the build pipeline creating the stub files based on the second indication, and the build pipeline compiling the first subgroup of the files based on the stub files.

In some examples, operation 1108 comprises, based on the compiling passing, the build pipeline generating a difference based on the compiling, wherein the difference is between the computer code, and the first subgroup of the files and stub files of the second subgroup of the files.

In some examples, operation 1108 comprises, based on the compiling failing, the build pipeline storing the first indication, the second indication, an indication of the compiling failing, and a difference based on the compiling, wherein the difference is between the computer code, and the first subgroup of the files and stub files of the second subgroup of the files.

This can be implemented in a similar manner as how recommendations are handled with respect to FIG. 8.

in some examples, the computer code is first computer code expressed in a first computer language, wherein the dependency map is a first dependency map, and operation 1108 comprises creating a second dependency map based on second computer code expressed in a second computer language that differs from the first computer language, and performing the nearest-neighbors analysis on the second dependency map. That is, the present techniques can be language agnostic as to programming languages used in the code base, and can be applied to code bases using different programming languages.

After operation 1108, process flow 1100 moves to 1110, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of computer system 102, target computer 106, and/or repository 110.

In some examples, computing environment 1200 can implement one or more embodiments of the process flows of FIGS. 9-11 to facilitate graph-powered compilable code extraction for migration workloads.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples, and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
creating a dependency map for computer code, wherein respective nodes of the dependency map comprise respective files of the computer code, wherein respective edges of the dependency map comprise respective dependencies between the respective files, and wherein respective properties of the respective nodes comprise respective computer code callable code construct signatures stored in the respective files; and
performing a k-hop analysis of the dependency map, wherein a first input parameter to the k-hop analysis comprises a location in the computer code from which to begin the k-hop analysis, wherein a second input parameter to the k-hop analysis comprises a depth value, wherein the performing of the k-hop analysis starts from the location in the computer code and extends through the computer code according to the depth value;
determining a first subgroup of the files to extract that corresponds an output of the performing of the k-hop analysis, and a second subgroup of the files for which to create stub files that corresponds to the output; and
storing a first indication of the first subgroup of the files and a second indication of the second subgroup of the files.

2. The system of claim 1, wherein the first subgroup of the files corresponds to at least one inner level of the output, and wherein the second subgroup of the files corresponds to an outer level of the output.

3. The system of claim 1, wherein at least one file of the files is omitted from the first subgroup and from the second subgroup.

4. The system of claim 1, wherein the creating of the dependency map for the computer code comprises:
omitting a circular dependency within the computer code from being represented in the dependency map.

5. The system of claim 1, wherein the callable code construct signatures comprise at least one method, at least one function, or at least one class.

6. The system of claim 1, wherein the operations further comprise:
determining at least one dependency of the first subgroup of the files or the second subgroup of the files; and
storing a third indication of the at least one dependency with the first indication of the first subgroup of the files and the second indication of the second subgroup of the files.

7. The system of claim 1, wherein the computer code is stored on a first computing system, and wherein the operations further comprise:
copying the first subgroup of the files and the stub files for the second subgroup of the files from the first computing system and to a second computing system.

8. The system of claim 7, wherein the operations further comprise:
compiling the first subgroup of the files on the second computing system, wherein the compiling is performed based on the stub files and independently of at least one file of the computer code that is outside of the first subgroup of the files.

9. A method, comprising:
creating, by a system comprising at least one processor, a dependency map for computer code, wherein respective nodes of the dependency map comprise respective files of the computer code, wherein respective edges of the dependency map comprise respective dependencies between the respective files, and wherein respective properties of the respective nodes comprise respective computer code callable code construct signatures stored in the respective files; and
performing, by the system, a nearest-neighbors analysis of the dependency map, wherein a first input parameter to the nearest-neighbors analysis comprises a location in the computer code, wherein a second input parameter to the nearest-neighbors analysis comprises a depth value, wherein the performing of the nearest-neighbors analysis starts from the location in the computer code and extends through the computer code according to the depth value; and
determining, by the system, a first subgroup of the files to extract that corresponds an output of the performing of the nearest neighbors analysis, and a second subgroup of the files for which to create stub files that corresponds to the output.

10. The method of claim 9, further comprising:
creating, by the system, a visualization of the first subgroup of the files and of the second subgroup of the files.

11. The method of claim 9, further comprising:
providing, by the system and to a build pipeline, a first indication of the first subgroup of the files and a second indication of the second subgroup of the files, the build pipeline writing first subgroup of the files and the stub files for the second subgroup of the files to a repository.

12. The method of claim 9, further comprising:
identifying a header or a prototype from the computer code, wherein the header or the prototype reconciles a dependency of the first subgroup of the files, and wherein the header or the prototype facilitates compilation of the first subgroup of the files.

13. The method of claim 9, wherein the location in the computer code identifies a directory that comprises first files, and wherein the nearest-neighbors analysis is performed relative to each of the first files.

14. The method of claim 9, further comprising:
creating, by the system, a concrete syntax tree from the computer code, wherein the creating of the dependency map is based on the concrete syntax tree.

15. A non-transitory computer-readable medium comprising instructions that, in response to execution, cause a system comprising at least one processor to perform operations, comprising:
creating a dependency map for computer code, wherein respective nodes of the dependency map comprise respective files of the computer code, and wherein respective edges of the dependency map comprise respective dependencies between the respective files;
performing a nearest-neighbors analysis of the dependency map, wherein a first input parameter to the nearest-neighbors analysis comprises a location in the computer code, and wherein a second input parameter to the nearest-neighbors analysis comprises a depth value; and
determining a first subgroup of the files to extract that corresponds an output of the performing of the nearest-neighbors analysis, and a second subgroup of the files for which to create stub files that corresponds to the output.

16. The non-transitory computer-readable medium of claim 15, wherein the operations further comprise:
providing a first indication of the first subgroup of the files and a second indication of the second subgroup of the files to a build pipeline, the build pipeline creating the stub files based on the second indication, and the build pipeline compiling the first subgroup of the files based on the stub files.

17. The non-transitory computer-readable medium of claim 16, wherein the operations further comprise:
based on the compiling passing, the build pipeline generating a difference based on the compiling, wherein the difference is between the computer code, and the first subgroup of the files and stub files of the second subgroup of the files.

18. The non-transitory computer-readable medium of claim 16, wherein the operations further comprise:
based on the compiling failing, the build pipeline storing the first indication, the second indication, an indication of the compiling failing, and a difference based on the compiling, wherein the difference is between the computer code, and the first subgroup of the files and stub files of the second subgroup of the files.

19. The non-transitory computer-readable medium of claim 15, wherein the respective nodes comprise respective properties, wherein the respective properties further comprise respective file names of the respective files, and wherein the respective properties further comprise respective file system path storage locations of the respective files.

20. The non-transitory computer-readable medium of claim 15, wherein the computer code is first computer code expressed in a first computer language, wherein the dependency map is a first dependency map, and wherein the operations further comprise:
creating a second dependency map based on second computer code expressed in a second computer language that differs from the first computer language; and
performing the nearest-neighbors analysis on the second dependency map.
